(19) United States
(12) Patent Application Publication
(10) Pub. No.: US 2026/0314558 A1
(43) Pub. Date: Oct. 15, 2026

(54) STALL SURFACE COVER SYSTEM AND METHOD OF USE

(71) Applicant: Ashley Heflin, Rising Star, TX (US)

(72) Inventor: Ashley Heflin, Rising Star, TX (US)

(21) Appl. No.: 19/548,579

(22) Filed: Feb. 24, 2026

Related U.S. Application Data
(63) Continuation of application No. 19/254,352, filed on Jun. 30, 2025.
Application No. 19/254,352 is a continuation-in-part of application No. 17/687,323, filed on Mar. 4, 2022, now abandoned.
Application No. 17/687,323 is a continuation of application No. 19/213,718, filed on May 20, 2025, now abandoned.
(60) Provisional application No. 63/755,707, filed on Feb. 7, 2025.

(51) Int. Cl. A01K 1/015

(52) U.S. Cl. CPC A01K 1/0157

(57) ABSTRACT

A stall surface cover system provides a standing surface within a pen or stall upon which an animal and its caretakers can stand within a portable stall. The body has a gripping layer to prevent slips and falls and a supportive layer such as closed-cell foam to hold the weight of the animal. The cover prevents damage to feet or soiling from dirt.

### BACKGROUND

### 1. Field of the Invention

The present invention relates generally to animal husbandry systems and methods, and more specifically, to a stall surface cover system that provides a clean and safe surface within a temporary stall for animals and their caretakers to stand on. The cover rolls up and is storable.

### 2. Description of Related Art

Animal husbandry systems are well known in the art and are effective means to care for animals in a non-native environment. Common animal husbandry systems include horse stalls and care for equines. A common temporary stall 101 is depicted in FIG. 1. A common stall 101 has walls 103 and a door 105 that encloses a space or area where a horse or other animals are kept. The space has floor 107 that is commonly dirt or soil. When the soil becomes wet from precipitation or urine it turns to mud. The temporary stall is able to be moved from one place to another. It can be erected in parking lots or buildings as well. In these cases, the floor is of pavement or concrete.

One of the problems associated with common animal husbandry systems is their limited efficiency. For example, the mud and dirt that get on show animals is undesirable as it detracts from their appearance. The mud and dirt must be cleaned from the animal prior to the show.

Additionally, when the temporary stall is constructed so that the floor is concrete or pavement this not good for the feet of the horses. The pavement damages their hooves and can cause injury.

Accordingly, although great strides have been made in the area of animal husbandry systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a common animal husbandry system;

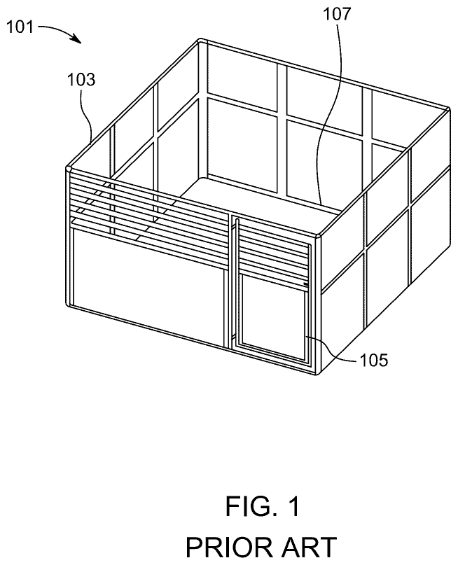

FIG. 2 is a perspective view of a stall surface cover system in accordance with a preferred embodiment of the present application;

FIG. 3 is a cross-sectional front view of the surface cover of FIG. 2;

FIG. 4 is a flowchart of a method of covering the floor of a stall; and

FIG. 5 is a top view of alternative embodiments of the indicia of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional animal husbandry systems. Specifically, the present invention provides for a protective layer to cover the floor of a stall to prevent mud and dirt from soiling the animal therein. Also, the invention provides a safe and supportive surface for the animals to stand on. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

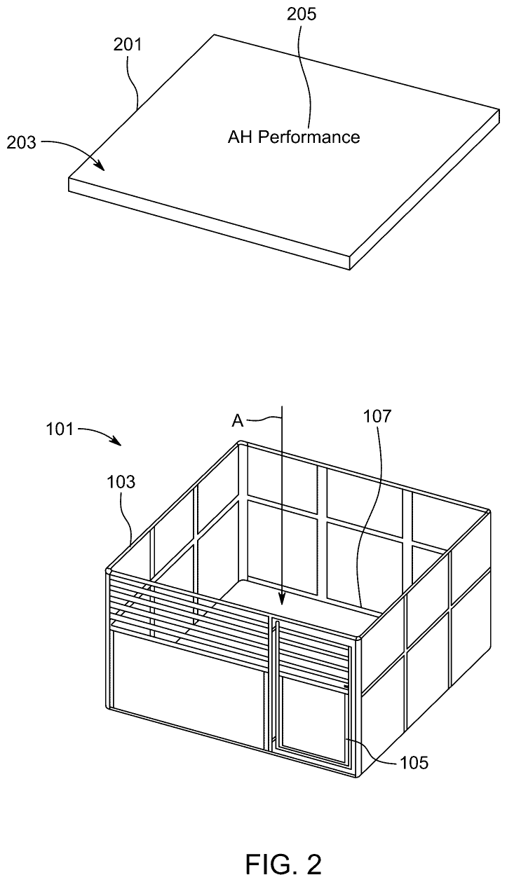

Referring now to the drawings wherein like reference characters identify corresponding or similar elements throughout the several views, FIG. 2 depicts a perspective view of a stall surface cover system in accordance with a preferred embodiment of the present application. It will be appreciated that system 201 overcomes one or more of the above-listed problems commonly associated with conventional animal husbandry systems.

In the contemplated embodiment, system 201 includes a surface cover body 201 with indicia 205 on the top surface 203 thereof. The surface cover body 201 is configured to fit on the floor 107 within the walls 103 of a stall 101 as depicted by motion A.

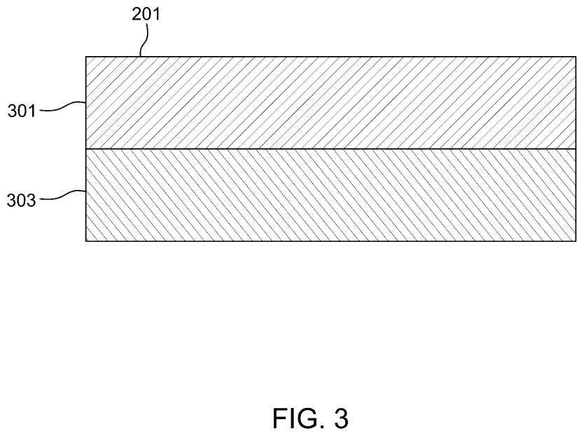

Referring now to FIG. 3 the surface cover body 201 includes gipping layer 301 attached to a supportive layer 303. In the preferred embodiment, supportive layer 303 is made of closed-cell foam. It is contemplated that both the top or gripping layer 301 and the bottom or supportive layer 303 could be made of cross-linked high-density foam.

In use, the stall 101 is lined with the surface cover body 201. Animals and people then walk, stand, or rest on the gripping layer 301 within the walls 103 of the stall 101. When the use of the stall 101 is done, the surface cover body 201 is rolled up and transported or stored for future use. The indicia 205 provides ambiance or instructional material to improve the use of the stall 101.

It should be appreciated that one of the unique features believed characteristic of the present application is that the supportive layer 303 provides a stable and safe surface upon which animals are able to stand while in a stall 101.

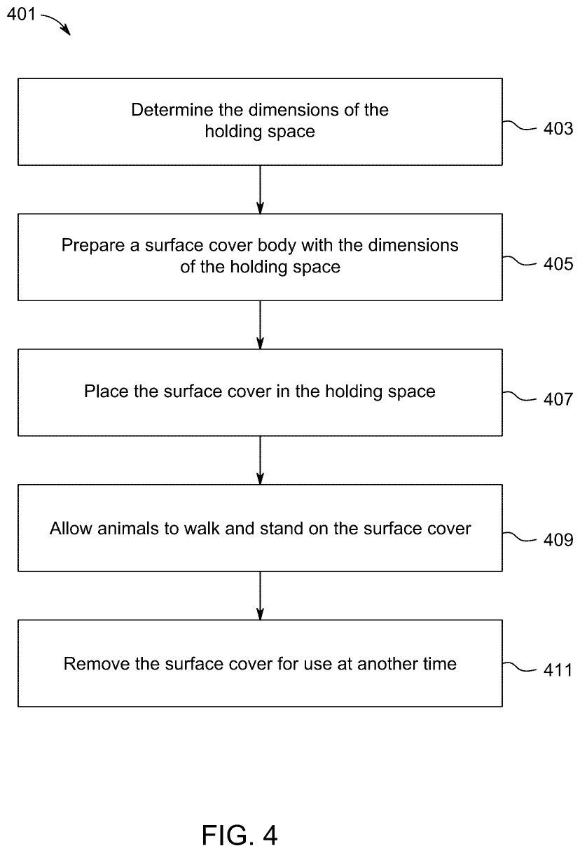

Referring now to FIG. 4 a method of covering the floor of a stall is depicted. Method 401 includes determining the dimensions of the holding space 403, preparing a surface cover body with dimensions of the holding space 405, placing the surface cover in the holding space 407, allowing animals to walk or stand on the surface cover 409, and removing the surface cover for use at another time 411.

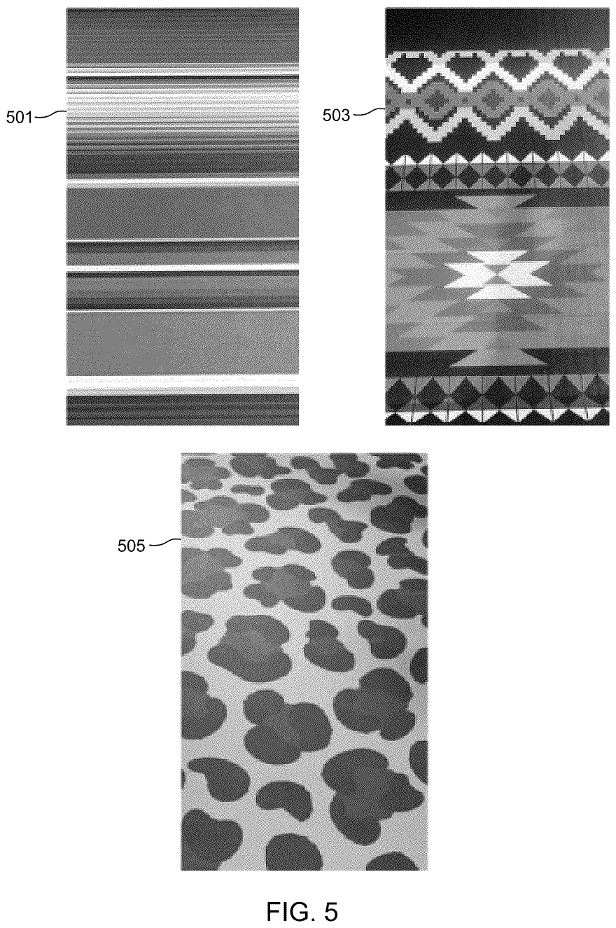

Referring now to FIG. 5 alternative embodiments of the indicia 205 are depicted. Embodiment 501 has a linear pattern 501 that resembles a rug or similar floor covering. Embodiment 503 has a woven pattern, and embodiment 505 has a leopard skin pattern. It is contemplated that indicia on the surface cover body could fill part or all of the upper surface 203 and be of any pattern.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A stall surface cover system comprising:
a portable stall having a floor supportive laver. the floor supportive layer is composed of a closed-cell foam;
a surface cover body with a top surface, the surface cover body is configured to secure to the floor supportive layer and is composed of a cross-linked high-density foam material that creates a gripping layer; and
an indicia placed on the top surface;
wherein the floor supportive layer and the gripping layer are integral with each other and are flexible such that the surface cover body is rolled onto itself;
wherein the surface cover body fits within the portable stall and covers the floor thereof.

2. (canceled)

3. (canceled)

4. The system of claim 1 wherein the top surface includes an indicia such as alphanumeric characters, patterns of lines, animal skin prints, or the like.

5. A method of covering the floor surface of a stall, comprising:
providing the stall surface cover system of claim 1;
determining a dimension of the floor supportive layer;
preparing the surface cover body with dimensions of the floor supportive layer;
placing the surface cover on the floor supportive layer;
allowing animals to walk or stand on the floor supportive layer; and
rolling the surface cover onto itself and removing the surface cover from the stall.
